(19) United States
(12) Patent Application Publication
(10) Pub. No.: US 2023/0090877 A1
(43) Pub. Date: Mar. 23, 2023

(54) MODULAR HIGH-EFFICIENCY PARTICULATE AIR FILTRATION SYSTEM FOR MAINTAINING NEGATIVE PRESSURE IN AN ISOLATED INDOOR SPACE

(71) Applicant: TREAD Corporation, Roanoke, VA (US)

(72) Inventors: Justin Matthews KREEGER, Roanoke, VA (US); Michael Wayne MCDANIEL, Roanoke, VA (US); Traci Ann MCDANIEL, Roanoke, VA (US)

(73) Assignee: TREAD Corporation, Roanoke, VA (US)

(21) Appl. No.: 17/901,910

(22) Filed: Sep. 2, 2022

Related U.S. Application Data
(60) Provisional application No. 63/245,449, filed on Sep. 17, 2021.

(51) Int. Cl. B01D 46/00; B01D 46/44; B01D 46/04; F24F 8/108; F24F 13/08

(52) U.S. Cl. CPC B01D 46/0086; B01D 46/446; B01D 46/04; F24F 8/108; F24F 13/08

(57) ABSTRACT

A modular high-efficiency particulate air (HEPA) filtration system includes first and second modular filtration units and a blower unit. The blower unit draws air from an isolated indoor space of a facility via a ventilation input to maintain negative air pressure within the isolated indoor space. The first modular filtration unit and the second modular filtration unit are connected in parallel with the ventilation input and the blower unit. The first modular filtration unit is disposed between the blower unit and the ventilation input and at least a portion of air drawn through the ventilation input by the blower unit passes through the first modular filtration unit, and the second modular filtration unit is disposed between the blower unit and the ventilation input and at least a portion of the air drawn through the ventilation input by the blower unit passes through the second modular filtration unit.

### CROSS-REFERENCE TO RELATED APPLICATIONS

This application claims the benefit of priority from pending U.S. Provisional Patent Application Ser. No. 63/245,449, filed on Sep. 17, 2021, and entitled “Modular High-Efficiency Particular Air Filtration System for Maintaining Negative Pressure in an Isolated Indoor Space.”

### BACKGROUND

Filtration systems are often used to filter out infectious and/or noxious agents from the air in hospitals, laboratories, and/or other facilities where such infectious and/or noxious agents may be present. Often such facilities are maintained at a negative air pressure to reduce the likelihood that such infectious and/or noxious agents may escape from the facility. Such filtration systems are typically custom built and may require significant amount of time, expenditure, and effort to set up. Thus, there is a need for a high efficiency air filtration system that may be rapidly deployed to meet rapidly evolving requirements.

### SUMMARY

An example data modular high-efficiency particulate air (HEPA) filtration system includes a first modular filtration unit, a second modular filtration unit, and a blower unit. The blower unit draws air from an isolated indoor space of a facility via a ventilation input to maintain negative air pressure within the isolated indoor space. The first modular filtration unit includes a first filter unit, and the second modular filtration unit includes a second filter unit. The first modular filtration unit and the second modular filtration unit are connected in parallel with the ventilation input and the blower unit. The first modular filtration unit is disposed between the blower unit and the ventilation input and at least a portion of air drawn through the ventilation input by the blower unit passes through the first modular filtration unit, and the second modular filtration unit is disposed between the blower unit and the ventilation input and at least a portion of the air drawn through the ventilation input by the blower unit passes through the second modular filtration unit. The blower unit comprises of a variable speed blower configured to provide an airflow up to 2000 cubic feet per minute (CFM) a pressure differential of at least 10 inches of water (inH₂O) and closed-loop control of air flow rate.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example modular high-efficiency particulate air filtration system for maintaining negative air pressure in an isolated indoor space according to the disclosure.

FIG. 2 is a diagram of an example filtration unit that may be used to implement the modular high-efficiency particulate air filtration system of FIG. 1.

FIG. 3 is a diagram of an example inlet transition weldment that that may be used to implement the filtration unit of FIG. 2.

FIG. 4 is a diagram of an example pre-filter unit that that may be used to implement the filtration unit of FIG. 2.

FIG. 5 is a diagram of an example HEPA filter unit that that may be used to implement the filtration unit of FIG. 2.

FIG. 6 is a diagram of an example upper slide plate that that may be used to implement the HEPA filter unit of FIG. 6.

FIG. 7 is a diagram of an example lower slide plate that that may be used to implement the HEPA filter unit of FIG. 6.

FIG. 8 is a diagram of an example door that that may be used to implement the pre-filter unit of FIG. 5.

FIG. 9 is a diagram of an example door that that may be used to implement the HEPA filter unit of FIG. 6.

FIG. 10 is a diagram of an example common collector that may be used to implement the inlet common collector, or the outlet common collector shown in FIG. 2.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

A modular high-efficiency particulate air (HEPA) filtration system for maintaining negative pressure in an isolated indoor space is provided. The modular HEPA filtration system provides a technical solution to the technical problem of providing a complete filtration system that can be rapidly deployed to a facility having an isolation area or other isolated indoor space requiring filtering of infectious and/or noxious agents from the air and for maintaining a negative air pressure within the isolation area. A technical benefit of the modular HEPA filtration system disclosed in the instant application is that the modular and skid-mounted configuration of the system facilitates rapid installation of the filtration system at a facility while minimizing disruption of the facility. In contrast, conventional filtration systems typically comprise numerous separate components, such as filter banks, blowers, and/or other components that may be selected, configured, and installed separately. The installation process for such systems often required significant lead time and required coordinating between multiple parties to engineer and install the various components of the filtration system. Furthermore, conventional systems often require significant modifications to be made to the facility in order to install the various components of the system. In contrast, the HEPA filtration system disclosed herein includes the modular components installed on a skid that may be installed indoors or outdoors depending on the needs and the configuration of the facility in which the system is being installed. Furthermore, the HEPA filtration system may be quickly retrofitted to utilize existing ductwork at the facility. The modular form factor of the HEPA filtration unit permits the system to be rapidly installed and/or expanded in response to an emergency such as a pandemic, a hazardous materials and/or radiological materials spill or accident, or other incident where there is a need to prevent the spreading of infectious and/or noxious agents from an insolation area.

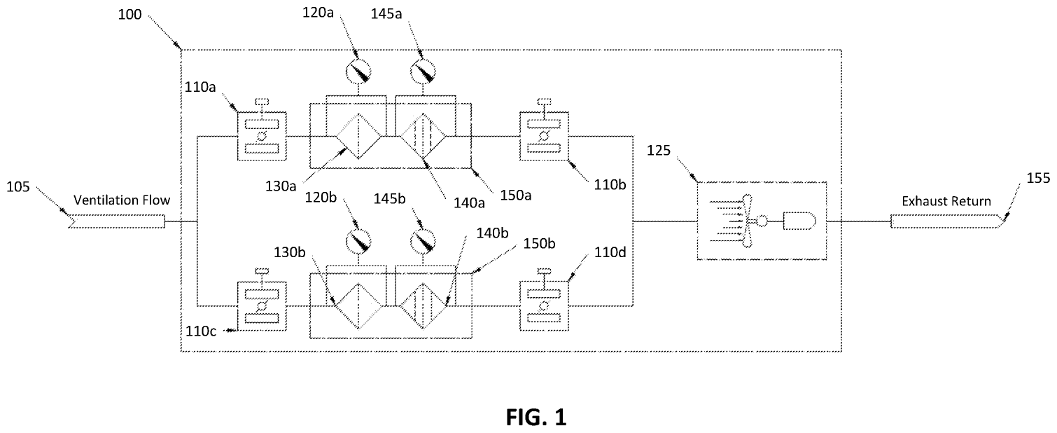

FIG. 1 is a diagram of an example modular high-efficiency particulate air filtration system 100 for maintaining negative air pressure in an isolated indoor space according to the disclosure. The filtration system 100 includes a ventilation input 105 representing an air duct drawing air from an isolated indoor space. The isolated indoor space may be an isolation ward of a hospital or other medical facility, a laboratory space, a designated area in a nursing home facility, or another area in which the capability to hold negative air pressure or negative ventilation is desired. Air travels from areas of high pressure to areas of low pressure. Maintaining a negative air pressure in the isolated indoor space relative to other spaces within the facility and/or the outdoor air pressure can prevent air from escaping from the isolated indoor space which may be carrying airborne infectious and/or noxious agents present inside the isolated indoor space.

The filtration system 100 draws air out of an isolated indoor space via the ventilation input 105 to maintain the negative air pressure within the isolated indoor space and to filter the air drawn out of the isolated indoor space before exhausting the filtered air into the atmosphere or into another portion of an indoor space which is outside of the isolated indoor space. For example, the filtered air may be exhausted into another part of the hospital, laboratory, nursing home facility, or other facility in which it is not required to maintain a negative air pressure.

The airflow will move through the filtration system 100 from the ventilation input 105 toward the exhaust output 155. The terms upstream and downstream are used herein to refer to the relative position of components of the filtration system 100 with respect to the airflow from the ventilation input 105 to the exhaust output 155. The terms “upstream” or “upstream component” as used to herein refer to a component of the filtration system 100 that is closer to the ventilation input 105 than a reference component. For example, the pre-filter 130a is upstream from the HEPA filter 140a shown in FIG. 1. Furthermore, the terms “downstream” or “downstream component” refer to a component that is closer to the exhaust output 155 than the reference component. For example, the HEPA filter 140a is downstream from the pre-filter 130a.

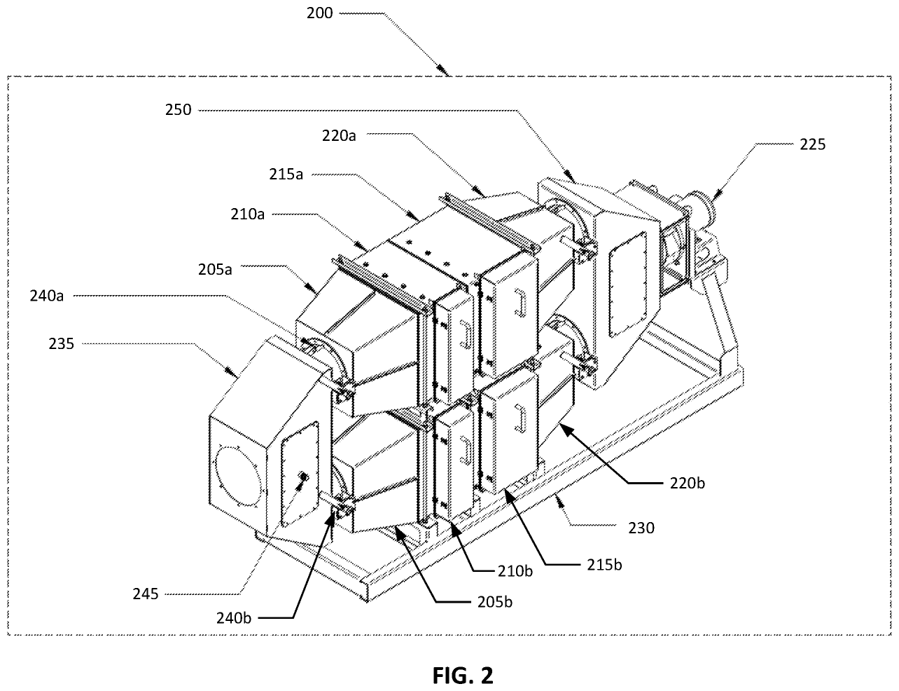

The filtration system 100 is configured to be modular and portable for easy installation on a rooftop, within a machine room, or outdoors on a concrete pad or other similar stable and relatively flat surface where the filtration system 100 may be set up. The filtration system 100 is configured to be set up with minimal disruption to the facility which is utilizing the filtration system 100. Retrofitting an existing facility to utilize the filtration system 100 is relatively quick and easy. In many implementations, the filtration system 100 can utilize existing ductwork. Furthermore, as will be described in greater detail with respect to FIG. 2, some implementation of the filtration system 100 includes multiple modular filtration units 210 and 215 that are easily customized to satisfy the filtration requirements of facilities having various types of filtration needs.

In the example implementation illustrated in FIG. 1, the filtration system 100 includes two modular filtration units 150a and 150b that may be operated in parallel. The ventilation input 105 may be divided between the two modular filtration units. The first modular filtration unit 150a may include a first isolation damper 110a and the second modular filtration unit 150b may include a second isolation damper 110c. The isolation damper 110a permits the airflow from the ventilation input 105 to be closed off to allow the first modular filtration unit 150a to be maintained, tested, or repaired. The isolation damper 110c permits the airflow from the ventilation input 105 to be closed off to allow the second modular filtration unit 150b to be maintained, tested, or repaired. Isolation dampers 110b and 110d may be actuated to fully isolate filter sections undergoing maintenance. The filtration system 100 is configured such that either the first modular filtration unit 150a or the second modular filtration unit 150b may be operated alone and maintain the desired negative air pressure within the isolated indoor space. This configuration allows one modular filtration unit to be maintained, tested, or repaired while the other modular filtration unit continues to operate normally. For example, one modular filtration unit may be sanitized and have the filters replaced while the other modular filtration unit continues operation.

The first modular filtration unit 150a includes a pre-filter 130a, a HEPA filter 140a, and common blower 125. The blower 125 is shown as being separate from the first modular filtration unit 150a, but a will be seen in FIG. 2, the first modular filtration unit 150a may include the blower 125 as a component. The first modular filtration unit 150a may include a first vacuum gauge 120a, and a second vacuum gauge 145a.

The pre-filter 130a is designed to remove particulate matter from the air entering the first modular filtration unit 150a from the ventilation flow 105 before the airflow reaches the HEPA filter 140a. The pre-filter 130a may extend the life of the HEPA filter 140a by capturing larger particulate matter from the airflow before this particulate matter reaches the HEPA filter 140a. The HEPA filter 140a is much finer filter than the pre-filter 130a and would tend to become clogged more quickly if the pre-filter 130a did filter the airflow before the airflow reaches the HEPA filter 140a. The pre-filter 130a is also significantly cheaper than the HEPA filter 140a and can result in significant cost savings by prolonging the life of the HEPA filter 140a. The pre-filter 130a may have varying thicknesses depending upon the type of particulate matters that may be present in the incoming airflow and the density of the particulate matters present in the incoming airflow. In one implementation the pre-filter 130a has a width of 24 inches, a height of 24 inches, and a thickness ranging from 1 to 6 inches.

The HEPA filter 140a is designed to remove a predetermined number of particles whose diameter is equal to 0.3 μm depending upon the HEPA standard that is being applied with the filtration efficiency increasing for particle diameters both less than and greater than 0.3 μm. The European Standard EN 1822-1:2009 for HEPA requires that at least 99.95% of the particles whose diameter is equal to 0.3 μm be removed. The American Society of Mechanical Engineers (ASME) standard ASME AG-1a-2004, and the United States Department of Energy (DOE) standards require at least 99.97% of the particles whose diameter is equal to 0.3 μm be removed. In one implementation the HEPA filter 140a has a width of 24 inches, a height of 24 inches, a thickness of 11.5 inches. In some implementations, the HEPA filter 140a provides for a flow rate of 2000 cubic feet per minute (CFM), which matches the upper end of the flow rate provided by the blower 125.

The blower 125 is configured to draw air from the ventilation input 105 into and through either modular filtration unit 150a or 150b to be exhausted through the exhaust output 155. The blower 125 may be a variable rate blower. Ideally, the blower is configured to provide an air flow rate of 2000 CFM and to generate a pressure differential of at least 10 inH₂O. The variable frequency drive of the blower 125 allows the flow rate to be decreased for implementations where the filtration system 100 is not required to generate a pressure differential of 10 inH₂O. For example, the blower 125 may be configured to provide other flow rates, such as but not limited to 800 CFM, 1200 CFM, and 1600 CFM where a lower pressure differential is required. The airflow rate can be adjusted downward to reduce the pressure differential in the system so that the air flow rate does not exceed the filtration capacity of the pre-filter 130a and/or the HEPA filter 140a.

The first vacuum gauge 120a measures the static pressure differential in the first modular filtration unit 150a across pre-filter 130a. The second vacuum gauge 145a measures the static pressure differential in the first modular filtration unit 150a across HEPA filter 140a. The pre-filter 130a and the HEPA filter 140a are expected to cause at least some decrease in pressure within the first modular filtration unit 150a as the airflow moves through the first modular filtration unit 150a. For example, the pre-filter 130a be rated to cause an expected 1 inch of water (inH₂O) decrease in pressure when new and may be expected to cause a 2 inH₂O decrease in pressure when it is time to replace the pre-filter 130a. The difference in pressure before and after the pre-filter 130a is displayed directly on vacuum gauge 120a. If this difference exceeds a predetermined threshold associated with the pre-filter 130a, then the pre-filter 130a should be replaced.

The HEPA filter 140a may be rated to cause an expected 1 inch of water (inH₂O) decrease in pressure when new and may be expected to cause a 2 inH₂O decrease in pressure when it is time to replace the HEPA filter 140a. The difference in pressure before and after the HEPA filter 140a is displayed directly on vacuum gauge 145a. If this difference exceeds a predetermined threshold associated with the HEPA filter 140a, then the HEPA filter140a should be replaced. The example expected pressure drops associated with the pre-filter 130a and the HEPA filter 140a are merely to illustrate the concepts described herein and do not limit the techniques disclosed herein to these specific examples of expected pressure drops.

The second modular filtration unit 150b in this example has an identical configuration as the first modular filtration unit 150a. However, in some implementations, the filtration system 100 may include modular filtration units that have different configurations. The second modular filtration unit 150b includes a pre-filter 130b, a HEPA filter 140b, and common blower 125. The blower 125 is shown as being separate from the second modular filtration unit 150b, but as will be seen in FIG. 2, the first modular filtration unit 150a and second modular filtration unit 150b may share the blower 125 as a component. The second modular filtration unit 150b may include a first vacuum gauge 120b, and a second vacuum gauge 145b. Each of these components may operation similarly to those included in the first modular filtration unit 150a. The pre-filter 130b is similar to the pre-filter 130a. The HEPA filter 140b is similar to the HEPA filter 140a. The first vacuum gauge 120b is similar to the first vacuum gauge 120a, and a second vacuum gauge 145b is similar to the second vacuum gauge 145a.

FIG. 2 is a diagram of an example modular filtration unit 200. The modular filtration unit 200 may be used to implement the first modular filtration unit 150a and the second modular filtration unit 150b shown in FIG. 1. The filtration unit 200 includes an inlet collector weldment 235, dampers 240a and 240b (collectively referred to as damper 240), inlet transition weldments 205a and 205b (collectively referred to as inlet transition weldment 205), pre-filter units 210a and 210b (collectively referred to as pre-filter unit 210), HEPA filter units 215a and 215b (collectively referred to as HEPA filter unit 215), damper transition weldments 220a and 220b (collectively referred to as damper transition weldment 220), an outlet common collector 250, and a blower 225. The dampers 240a and 240b are configured and operate similarly. The inlet transition weldments 205a and 205b are configured and operate similarly. The pre-filter units 210a and 210b are configured and operate similarly. The HEPA filter units 215a and 215b are configured and operate similarly. The damper transition weldments 220a and 220b are configured and operate similarly.

In some implementations, the housing of each of the components of the modular filtration unit 200 are constructed using stainless steel and/or other materials that can withstand the potentially harsh cleaning using water and/or disinfecting agents that may corrode or otherwise damage other materials. In some implementations, the components of the modular filtration unit 200 include drain plugs that are kept in place during operation of the modular filtration unit 200 to ensure that the modular filtration unit 200 remains substantially airtight. The drain plugs are be removed prior to cleaning to allow water and/or disinfecting agents to drain from the modular filtration unit 200. The plugs are replaced once the modular filtration unit 200 has been sanitized.

The filtration unit 200 is disposed on a set of skids 230 on which the previously described elements of the filtration unit 200 are mounted. The skids 230 are modular process skids which provide a framework upon which the filtration unit 200 can be assembled. The set of skids 230 includes a set of lifting eyes or lifting lugs that may be used to hoist the filtration unit 200 into place. The components of the filtration unit 200 may be preinstalled on the skids prior to being deployed to the facility at which the filtration unit 200 is to be installed. The modular form factor facilitates quick installation on a rooftop, on a concrete pad, in a machine room or other location. Furthermore, the modular form factor allows multiple filtration units 200 to be stacked and/or placed side by side. An additional filtration unit 200 may be quickly added to an existing installation where additional isolated area is required. For example, an additional filtration unit 200 may be added in response to additional isolated treatment area being needed for treating additional patients at a hospital. Thus, the filtration systems provided herein can quickly grow and adapt to meet the needs of the facility.

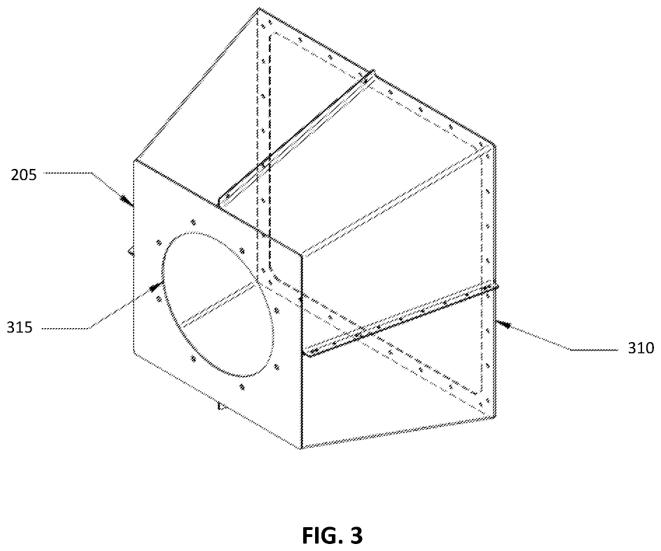

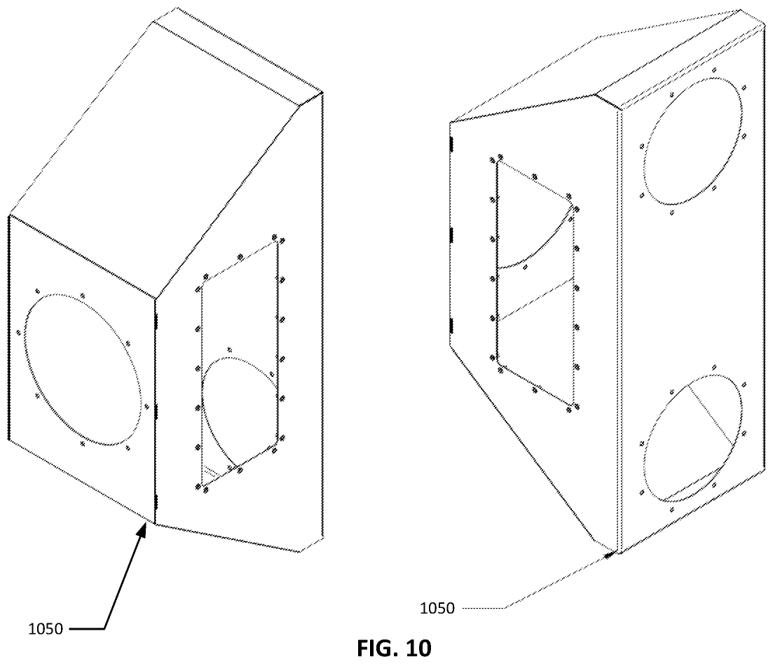

The inlet collector weldment 235 may be connected to a duct which in turn connects to the ventilation input 105. FIG. 10 is a diagram showing two views of an example collector weldment 1050 that may be used to implement the inlet collector weldment 235. As discussed with respect to FIG. 1, in some implementations, an isolation damper 240 is disposed between the ventilation input 105 and the inlet transition weldment 205 to cut off the air flow from the ventilation input 105 to permit the filtration unit 200 to be maintained, tested, or repaired. FIG. 3 is a diagram of an example construction of the inlet transition weldment 205 that provides additional details of the inlet transition weldment 205 shown in

The inlet collector weldment 235 includes a face to which an adaptor plate (not shown) may be bolted. The adaptor plate may be used to attach to duct carrying the air from the ventilation input 105 to the filtration unit 200. The size and shape of the duct may vary. Each adaptor plate may be configured to provide an airtight seal with a particular shape and size of duct at one end and to attached to the face of the inlet collector weldment 235 at the other end. The use of such attachment plates allows a standard inlet collector weldment 235 to be fitted to various types of ducts at may be found or are to be used at a facility where the filtration unit 200 is to be installed. This approach allows the modular filtration unit 200 to be used in a variety of installations without having to customize the inlet collector weldment 235 or other components of the modular filtration unit 200 for a particular installation. Thus, the modular filtration unit 200 may be quickly assembled in advance and/or onsite with a standard set of components that do not require customization. This approach may be particularly desirable where there is a need to have the modular filtration unit 200 set up and operational as quickly as possible.

The inlet transition weldment 205 includes a first flange 315 and a second flange 310. The first flange 315 is to the damper 240 or another upstream component. The flange 310 of the inlet transition weldment 205 is of a standard height and width as other components of the modular filtration unit 200, which allows the inlet transition weldment 205 to be securely bolted to the next component of the modular filtration unit 200. In this example, the inlet transition weldment 205 connected with the pre-filter unit 210.

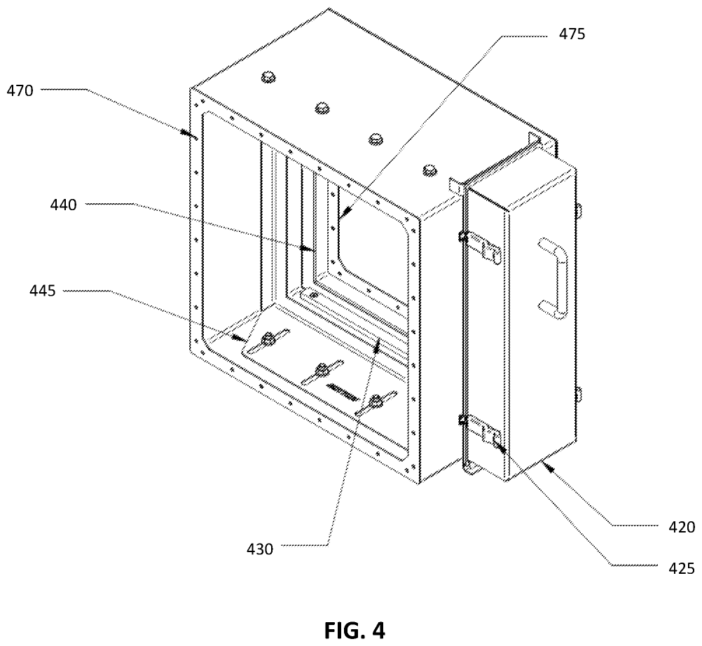

Referring again to FIG. 2, the pre-filter unit 210 includes the pre-filter used to remove particulate matter from the airflow before the airflow reaches the HEPA filter of the HEPA filter unit 215 downstream from the pre-filter unit 210. An example of a pre-filter unit 210 is shown in FIG. 4. The pre-filter unit 210 includes a first flange 470 and a second flange 475. The first flange 470 is of a standard size for each of the components of the filtration unit 200 and may be used to securely bolt the pre-filter unit 210 to an upstream component. The upstream component in this example is the inlet transition weldment 205 but could be a different component in other implementations of the filtration unit 200. The second flange 475 is also of the standard size for each of the components of the filtration unit 200 and may be used to securely bolt the pre-filter unit 210 to a downstream component of the filtration unit 200. The downstream component in this example is the HEPA filter unit 215 but could be a different component in other implementations of the filtration unit 200.

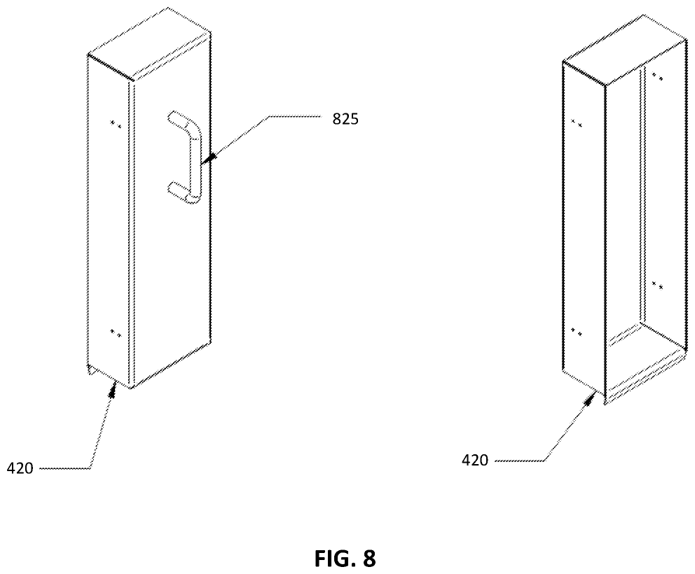

The pre-filter unit 210 includes an access door 420 that is held in place by a series of latches 425. The latches 425 can be unfasted to permit the door 420 to be removed from the pre-filter unit 210. An example implementation of the door 420 is shown in FIG. 8 that shows the outside of the door including the handle 825 and the interior of the door. The door 420 may be formed from stainless steel, aluminum, or other material that is substantially similar to that of the body of the pre-filter unit 210. The door 420 may be removed to insert a filter (not shown) into the pre-filter unit 210.

The pre-filter unit 210 includes a glide rail 430 that serves to guide the pre-filter into the proper position within the pre-filter unit 210. In some implementations, the glide rail 430 is formed from ultra-high molecular weight polyethylene (UHMW) which provides high abrasion and wear resistance. UHWM is also low friction and is also highly resistant to many chemicals.

The pre-filter unit 210 includes a slide rack 445 that is configured to accommodate pre-filters of varying thickness. The slide rack 445 includes a lip that is configured to press against a perimeter of the upstream side of the pre-filter. The downstream side of the pre-filter includes a gasket disposed around the perimeter of the pre-filter. In some implementations, the gasket is formed from neoprene or another compressible material that may be compressed against the sealing face 440 located on the downstream side of the pre-filter unit 210. The slide rack 445 may be adjusted to compress the pre-filter against the sealing face 440 to create an airtight seal around the pre-filter to force the airflow through the pre-filter unit 210 to pass through the pre-filter.

The pre-filter unit 210 is configured to provide bag in/bag out access to the pre-filter within the pre-filter unit 210 in some implementations. The air being drawn through the filtration unit 200 may include infectious agents and/or noxious materials that may be harmful to maintenance personnel who are replacing a used pre-filter. The pre-filter unit 210 implements a bag in/bag out system in which the maintenance personnel never directly come into contact with the pre-filter or the interior of the pre-filter unit 210. The pre-filter is inserted into the pre-filter unit 210 and a bag is sealed around the door frame of the pre-filter unit 210 that accommodates the door 420. When maintenance personnel need to replace the pre-filter, the bag remains sealed around the door frame so that the maintenance personnel do not come into direct contact with any contaminated interior surface of the pre-filter unit 210 or the pre-filter itself. The bag is unrolled while remaining sealed around the door frame area and the used pre-filter is pulled into the bag. The bag is sealed off with the contaminated pre-filter inside of the sealed bag. A new pre-filter inside of a replacement bag is then inserted into the pre-filter unit 210 and the new bag affixed to the door frame of the pre-filter unit 210. Once the filter is in place and the bag is sealed to the door frame, the bag may be pulled from the interior of the pre-filter unit 210 and stored in the interior area at the back of the door 420. This interior area of the door is shown in FIG. 8.

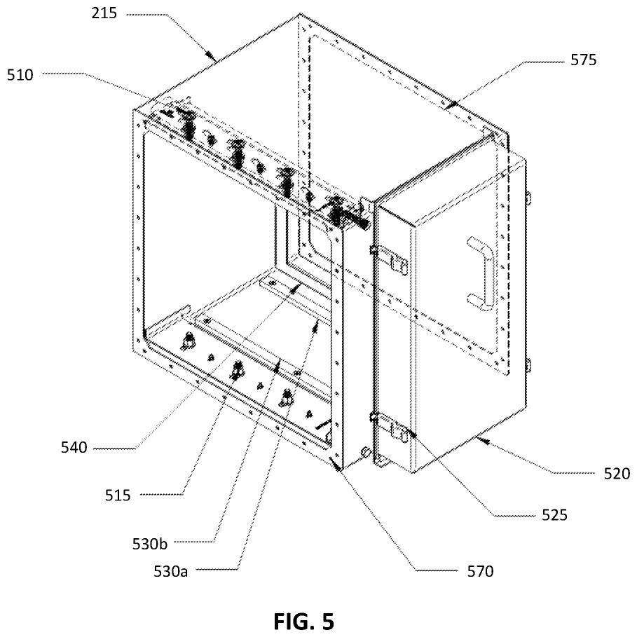

The HEPA filter unit 215 is the next downstream unit from the pre-filter unit 210. The HEPA filter unit 215 includes a HEPA filter rather than a pre-filter. An example of a HEPA filter unit 215 is show in FIG. 5. The HEPA filter unit 215 includes a first flange 570 and a second flange 575 in some implementations. The first flange 570 is of a standard size for each of the components of the filtration unit 200 and may be used to securely bolt the HEPA filter unit 215 to an upstream component. The upstream component in this example is the pre-filter unit 210 but could be a different component in other implementations of the filtration unit 200. The second flange 575 is also of the standard size for each of the components of the filtration unit 200 and may be used to securely bolt the HEPA filter unit 215 to a downstream component of the filtration unit 200. The downstream component in this example is the transition weldment 220 but could be a different component in other implementations of the filtration unit 200.

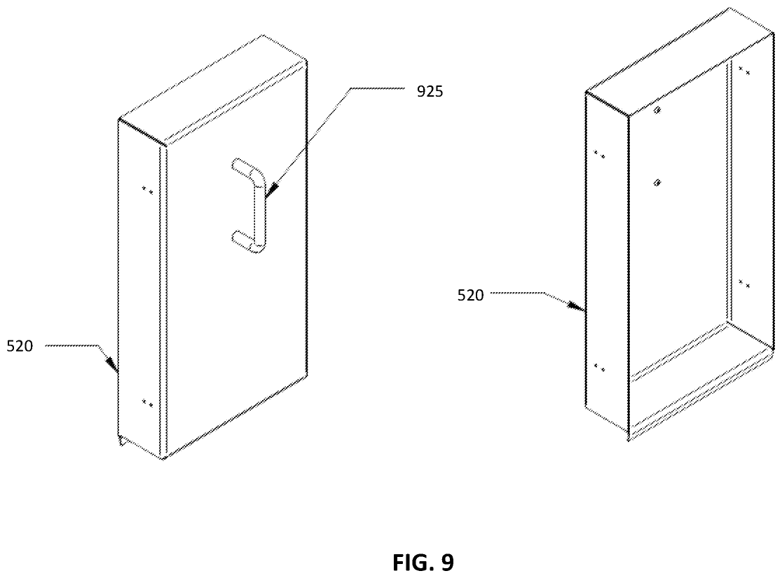

The HEPA filter unit 215 includes a door 520 for accessing the interior of the HEPA filter unit 215 to insert or replace a HEPA filter. The door utilizes latches 525 similar to the latches 425 used by the door 420 of the pre-filter unit 210. The latches 525 keep the door in place during operation of the filtration unit 200 and can be unlatched to allow removal of the door 520. FIG. 9 shows an example implementation of the door 520 which includes a handle 925.

The HEPA filter unit 215 may include a set of glide rails 530a and 530b that serve to guide the HEPA filter into the proper position within the HEPA filter unit 215. The glide rails 530a and 530b may be formed from UHMW which provides high abrasion and wear resistance. UHWM is also low friction and is also highly resistant to many chemicals. The upper slide plate 510 and the lower slide plate 515 also include features to help guide the filter into place. For example, the upper slide plate 510 may include an arm 655 and the lower slide plate 515 may include an arm 755. The arms 655 and 755 are configured to stop the HEPA filter at the proper location as the filter is being inserted into the HEPA filter unit 215, so that a gasket of the HEPA filter properly aligns with the sealing face 540 of the HEPA filter unit 215.

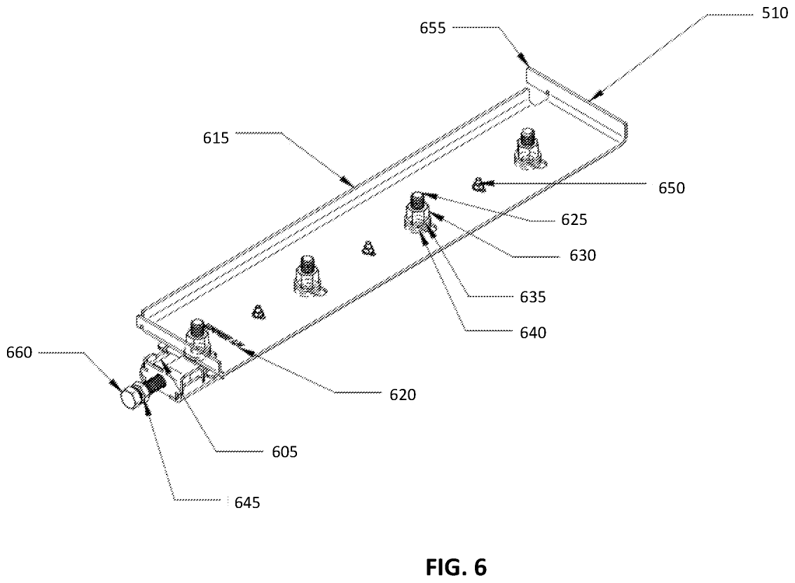

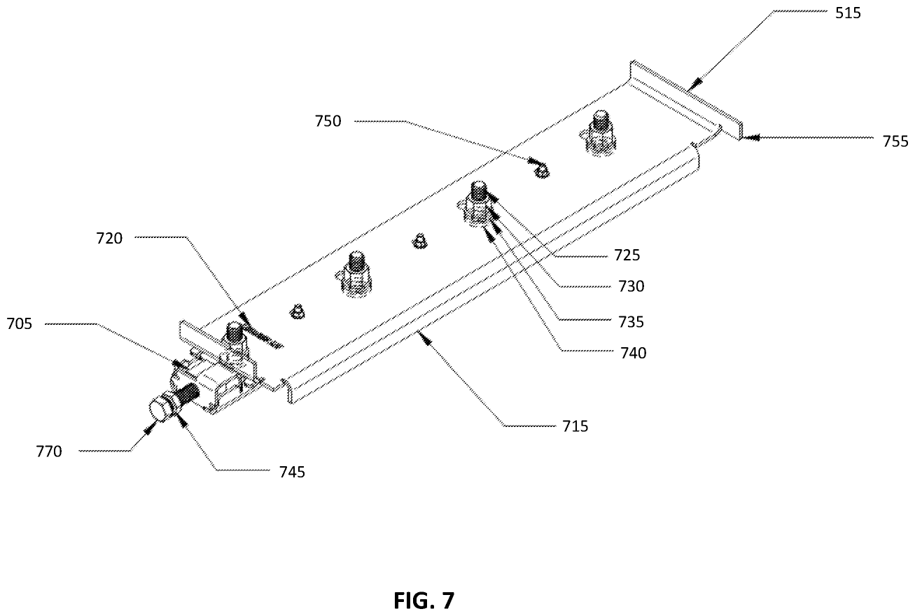

The HEPA filter unit 215 includes an upper slide plate 510 attached to the top of the upstream side of the HEPA filter unit 215. The upper slide plate 510 is not clearly shown in FIG. 5, but an example implementation of the upper slide plate is shown in FIG. 6. The bolt of the upper slide plate can be seen extending from the housing of the HEPA filter unit 215 in FIG. 5. The lower slide plate 515 is attached to the bottom of the upstream side of the HEPA filter unit 215. An example implementation of the lower slide plate 515 is shown in FIG. 7. The upper slide plate 510 includes a lip 615 that is configured to press against the upstream side of the HEPA filter and force the downstream side of the HEPA filter toward the sealing face 440 located on the downstream side of the HEPA filter unit 215. The downstream side of the HEPA filter includes a gasket disposed around the perimeter of the HEPA filter. The upper slide plate 510 and the lower slide plate 515 are adjustable to compress the gasket of the HEPA filter against the sealing face 540 to create an airtight seal around the HEPA filter to force the airflow through the HEPA filter unit 215 through the HEPA filter. The gasket may be formed from neoprene or another malleable material that may be seated against the sealing face 540 to prevent airflow from passing around rather than through the HEPA filter.

The upper slide plate 510 and the lower slide plate 515 operate independently of one another in the implementation illustrated in FIG. 2. The upper slide plate 510 includes a threaded block 605 and the lower slide plate 515 includes a threaded block 705 each of which are held in a fixed position. Turning the bolt 660 of the upper slide plate in a first direction causes the upper slide plate 510 to move toward the bolt and turning the bolt 660 in a second direction opposite the first direction causes the upper slide plate 510 to move away from the bolt 660. This horizontal motion is translated into upstream or downstream motion of the upper slide plate 510. When the upper slide plate 510 moves toward the upstream side of the HEPA filter unit 215, the lip 615 presses against an upper edge of the upstream side of the HEPA filter forcing the HEPA filter toward the downstream side of the HEPA filter unit 215. Thus, the gasket of the HEPA filter may be compressed against the sealing face 540 of the HEPA element 215 to create a seal that forces the airflow through the HEPA filter. When the upper slide plate 510 moves away from the upstream side of the HEPA filter unit 215, the lip 615 releases the upper edge of the downstream side of the HEPA filter allowing the HEPA filter to be removed and/or replaced.

Turning the bolt 770 of the lower slide plate 515 in a first direction causes the lower slide plate 515 to move toward the bolt and turning the bolt 770 in a second direction opposite the first direction causes the lower slide plate 515 to move away from the bolt 770. This horizontal motion is translated into upstream or downstream motion of the slide plate 515. When the lower slide plate 515 moves toward the upstream side of the HEPA filter unit 215, the lip 715 presses against an upper edge of the upstream side of the HEPA filter forcing the HEPA filter toward the downstream side of the HEPA filter unit 215. Thus, the gasket of the HEPA filter may be compressed against the sealing face 540 of the HEPA element 215 to create a seal that forces the airflow through the HEPA filter. When the lower slide plate 515 moves away from the upstream side of the HEPA filter unit 215, the lip 715 releases the upper edge of the downstream side of the HEPA filter allowing the HEPA filter to be removed and/or replaced.

The upper slide plate 510 and the lower slide plate 515 each include features that provide significant technical improvements in the operation of the slide plates compared with conventional solutions. In a conventional implementation of a slide plate that may be used to compress a filter in a conventional filtration system, the slide plate may include bolts that project through a channel in the slide plate and include a nut that holds the slide plate in position. Friction between the slide plate and the nut and/or bolt hold the slide plate in a preferred position. The position of the slide plate may be adjusted using a bolt similar to the bolt 660 or 770 shown in FIGS. 5, 6, and 7. However, adjusting the position of the conventional slide plate may require a significant amount of torque on the bolt because the force applied to the bolt must also overcome the friction between the slide plate and the nut and/or bolt holding the slide plate in position. The improved slide plate configurations shown in FIGS. 5, 6, and 7 overcome this and other technical problems associated with the designs of the conventional slide plates to allow greatly improved consistency of applied clamping force.

The upper slide plate 510 shown in FIG. 6 includes a set of bolts, such as the bolt 625 that each have a nut 630 for holding the upper slide plate 510 in position. The bolt 625 is inserted through a slot 640 through the upper surface 620. A bushing 635 is disposed on the bolt 625 between the nut 630 and the top surface 620 of the upper slide plate 510. The bushing 635 permits the upper slide plate 510 to move relative to the bolt 625 and the nut 630. The upper slide plate 510 does not rely on friction between the nut 630 and the upper surface 620 of the upper slide plate 510 to maintain the position of the slide plate 510 as in the conventional slide plates. Instead, the bolt 660 includes a serrated locking washer 645 that is configured to hold the bolt 660 in position once the position of the upper slide plate 510 has been adjusted using the bolt.

The movement of the upper slide plate 510 in the upstream or downstream direction is implemented by the inclusion of a set of cam followers, such as the cam follower 650, which are each inserted through a respective slot through the upper surface 620 that is angled relative to the length of the upper slide plate 510. The cam followers translate horizonal motion of the surface place caused by turning the bolt 660 into lateral upstream or downstream motion of the upper slide plate 510. The cam followers may comprise a bolt with a tube of stainless steel slid over the bolt and a nut to hold the tube in place. The tube of stainless steel may freely rotate about the bolt. This reduces friction between the upper slide plate 510 and the cam followers. The configuration of the upper slide plate 510 shown in FIG. 6 may significantly reduce friction between the slide plate and the bolts and/or cam followers. The use of low friction components allows more of the work being applied to turning the bolt to be applied toward the lateral motion of the slide plate than in conventional implementations of such a slide plate for holding a filter in a ventilation system.

The lower slide plate 515 shown in FIG. 7 includes a set of bolts, such as the bolt 725 that each have a nut 730 for holding the lower slide plate 515 in position. The bolt 725 is inserted through a slot 740 through the upper surface 720. A bushing 735 is disposed between the nut 730 and the upper surface 720 of the lower slide plate 515. The bushing 735 permits the lower slide plate 515 to move relative to the bolt 725 and the nut 730. The lower slide plate 515 does not rely on friction between the nut 730 and the upper surface 720 of the lower slide plate 515 to maintain the position of the lower slide plate 515 as in the conventional slide plates. Instead, the bolt 770 includes a serrated locking washer 745 holds the bolt 770 in position once the position of the lower slide plate 515 has been adjusted using the bolt.

The movement of the lower slide plate 515 in the upstream or downstream direction is facilitated by the inclusion of a set of cam followers, such as the cam follower 750, which are each inserted through a respective slot through the upper surface 720 that is angled relative to the length of the lower slide plate 515. The cam followers translate horizonal motion of the surface place caused by turning the bolt 770 into lateral upstream or downstream motion of the lower slide plate 515. The cam followers may comprise a bolt with a tube of stainless steel slid over the bolt and a nut to hold the tube in place. The tube of stainless steel may freely rotate about the bolt. This reduces friction between the lower slide plate 515 and the cam followers. The configuration of the lower slide plate 515 shown in FIG. 7 may significantly reduce friction between the slide plate and the bolts and/or cam followers. The use of such low friction components allows more of the work being applied to turning the bolt to be applied toward the lateral motion of the slide plate than in conventional implementations of such a slide plate for holding a filter in a ventilation system.

The HEPA filter unit 215 uses a bag in/bag out configuration similar to that described with respect to the pre-filter unit 210 to protect maintenance personnel who are removing and/or replacing a used HEPA filter. The door 420 includes space for storing the sealing bag while the HEPA filter unit 215 is in operation.

The outlet collector weldment 250 connects the HEPA filter unit 215 to the blower 225. FIG. 10 is a diagram showing two views of an example collector weldment 1050 that may be used to implement the outlet collector weldment 250. The blower 225 may be a variable frequency blower similar to the blower shown in FIG. 1. The blower 225 is configured to draw air through the filtration unit 200 to be filtered by the pre-filter unit 210 and the HEPA unit 215. Ideally, the blower is configured to provide an air flow rate of 2000 CFM and to generate a pressure differential of at least 10 inH₂O. The variable frequency drive of the blower 125 allows the flow rate to be decreased for implementations where the filtration unit 200 is not required to generate a pressure differential of 10 inH₂O. For example, the blower 125 may be configured to provide other flow rates, such as but not limited to 800 CFM, 1200 CFM, and 1600 CFM where a lower pressure differential is required. The airflow rate can be adjusted downward less of a pressure differential is required so that the airflow rate does not exceed the filtration capacity of the pre-filter 130a and/or the HEPA filter 140a.

The modular filtration unit 200 includes means for testing the efficiency of the unit. The modular filtration unit 200 may need to undergo periodic testing to ensure that the modular filtration unit 200 is removing the particulate matter from the airflow at the required efficiency. Such testing is particularly important where the air exhausted by the modular filtration unit 200 is introduced to an indoor environment where people may be located. To facilitate such testing, the inlet collector weldment 235 includes a test port fitting 245 in some implementations. The test port fitting 245 provides an opening through which a technician may insert an aerosol injector that introduces a test aerosol into the inlet transition weldment 205. The test aerosol contains a distribution of particles that are meant to test the efficiency of the HEPA element. The test aerosol is introduced into the modular filtration unit 200 while the blower 225 is operating in order to pull the aerosol through the filter units.

In some implementations, the modular filtration unit includes a pre-sample port that is in the housing of the HEPA filter unit 215 prior to the air flow passing through the HEPA filter. An optical sensor is introduced into the pre-sample port to determine whether the expected particulates from the test aerosol have reached the HEPA filter unit 215 as expected. A downstream port may be included in the HEPA filter unit 215 or in the weldment 220 located downstream the HEPA filter. In the example implementation shown in FIG. 2, the weldment 220 includes a downstream port through which an optical probe may be inserted. The optical probe is configured to detect the particulate matter included in the test aerosol. If particulate matter above a specified concentration from the test aerosol is detected downstream from the HEPA filter, this indicates that the HEPA filter is not operating correctly and may need to be replaced. The filter material itself may have failed or the sealing of the filter element to the sealing face may have failed. Alternatively, another component of the system may have developed a leak which is allowing at least a portion of the airflow through the filtration system 200 to bypass the HEPA filter. If the optical probe does not detect the particulate matter of the test aerosol, the filtration system 200 is capturing the particulate matter as required and may be recertified for operation until the next testing and recertification is required.

The modular design of the filtration unit 200 allows the unit 200 to be quickly assembled in advance and transported to a facility where the modular filtration unit 200 is to be installed and/or to be rapidly assembled on site from the components described above. The modular nature of the modular filtration unit 200 allows the device to be customized based on the needs of the facility at which the modular filtration unit 200 is to be deployed. For example, additional filtration units may be added to the modular filtration unit 200 configuration shown in FIG. 2. Furthermore, the output of the blower 225 may be rotated in 90-degree increments to facilitate the exhaust output being directed to a particular location. Furthermore, the modular filtration unit 200 may be installed on skids, such as the skids 230, which may be of a customized length based on the sizes of the components included in a particular configuration of the modular filtration unit 200.

In some implementations, the pre-filter housing weldment 210, HEPA housing weldment 215 and blower transition weldment 220 include an ultraviolet (UV) disinfection component (not shown) that may be used to sanitize the interior and filter elements. The UV disinfection component disinfects the blower and the blower transition weldment 220 to allow maintenance personnel to safely remove, replace, maintain, or service the blower 225 without requiring the entire filtration unit 200 to be fully sanitized. In some implementations, the UV disinfection component includes one or more UV light sources mounted along the interior walls of the blower transition weldment 220. The length of the blower transition weldment 220 may be increased to provide additional space for including the one or more UV light sources. The filtration unit 200 is shut down and the UV light source operated for a predetermined period of time to sanitize the exposed area.

In some implementations, blower 125 is controlled by variable frequency drive and controller logic to monitor differential pressure across the blower plenum. Pressure drop across the plenum is used to calculate air flow rate at a standard temperature and pressure, and the blower speed is adjusted automatically to accommodate for varying levels of filter loading to maintain a consistent air flow rate through filter section 150a or 150b. A drop in pressure may indicate that the pre-filter and/or the HEPA filter are becoming blocked, thereby causing a drop in the air flow rate. The differential pressure may be determined based on measurements obtained from the first vacuum gauges 120a and 120b, the second vacuum gauges 145a and 145b, or sensing ports located on the plenum of the blower 125.

The detailed examples of systems, devices, and techniques described in connection with FIGS. 1-10 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-10 are implemented in respective modules, which may also be referred to as, and/or include, logic, components, units, and/or mechanisms. Modules may constitute either software modules (for example, code embodied on a machine-readable medium) or hardware modules.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A modular high-efficiency particulate air (HEPA) filtration system comprising:
a blower unit for drawing air from an isolated indoor space of a facility via a ventilation input to maintain negative air pressure within the isolated indoor space;
a first modular filtration unit comprising a first filter unit; and
a second modular filtration unit comprising a second filter unit, wherein:
the first modular filtration unit and the second modular filtration unit are connected in parallel with the ventilation input and the blower unit,
the first modular filtration unit is disposed between the blower unit and the ventilation input and at least a portion of air drawn through the ventilation input by the blower unit passes through the first modular filtration unit,
the second modular filtration unit is disposed between the blower unit and the ventilation input and at least a portion of the air drawn through the ventilation input by the blower unit passes through the second modular filtration unit, and
the blower unit comprises of a variable speed blower configured to provide closed-loop control of air flow rate.

2. The HEPA filtration system of claim 1, wherein the variable speed blower is configured to provide an airflow up to 2000 cubic feet per minute (CFM) a pressure differential of at least 10 inches of water (inH₂O).

3. The HEPA filtration system of claim 1, further comprising:
first and second isolation dampers configured to close off airflow from the ventilation input to the first modular filtration unit to permit the first modular filtration unit to be maintained, tested, or repaired while the second modular filtration unit continues to draw air from the isolated indoor space to filter the air; and
third and fourth isolation dampers configured to close off the airflow from the ventilation input to the second modular filtration unit to permit the second modular filtration unit to be maintained, tested, or repaired while the first modular filtration unit continues to draw air from the isolated area to filter the air.

4. The HEPA filtration system of claim 1, wherein the first filter unit of the first modular filtration unit comprises:
a HEPA filter unit comprising a HEPA filter configured to filter out a predetermined threshold of particulate matter from air passing through the HEPA filter; and
a pre-filter unit disposed upstream from the HEPA filter unit, wherein the pre-filter unit comprises a pre-filter configured to filter out particulates larger than a predetermined size to prevent particles larger than the predetermined size from reaching the HEPA filter.

5. The HEPA filtration system of claim 4, wherein the pre-filter is installed and removed in a bag to prevent maintenance personnel inserting or removing the pre-filter from coming into contact with an interior of the pre-filter unit or a used pre-filter, and wherein a door of the pre-filter unit is configured to form a seal with and store the bag until the used pre-filter is removed from the pre-filter unit.

6. The HEPA filtration system of claim 4, wherein the HEPA filter is installed and removed in a bag to prevent maintenance personnel inserting or removing the HEPA filter from coming into contact with an interior of the HEPA filter unit or a used HEPA filter, and wherein a door of the HEPA filter unit is configured to form a seal with and store the bag until the used HEPA filter is removed from the HEPA filter unit.

7. The HEPA filtration system of claim 1, wherein the first filter unit of the first modular filtration unit comprises:
a pre-sample port through a housing of the first modular filtration unit, the pre-sample port located upstream from the HEPA filter; and
a first optical sensor inserted into an interior of the first modular filtration unit through the pre-sample port to detect a first concentration level of a particulate matter of a test aerosol introduced into the first modular filtration unit upstream from the HEPA filter.

8. The HEPA filtration system of claim 7, wherein the at least one filter unit of the first modular filtration unit comprises:
a downstream port through the housing of the first modular filtration unit, the downstream port located downstream from the HEPA filter; and
a second optical sensor inserted into the interior of the first modular filtration unit through the downstream port to detect a second concentration level of the particulate matter downstream of the HEPA filter, where the second concentration level exceeding a predetermined threshold concentration level being indicative of the HEPA filter needing to be replaced.

9. The HEPA filtration system of claim 4, wherein the first modular filtration unit further comprises:
a first pressure drop indicator configured to measure a first pressure drop over the pre-filter; and
a second pressure drop indicator configured to measure a second pressure drop over the HEPA filter.

10. The HEPA filtration system of claim 9, wherein the first pressure drop indicator is configured to obtain a first pressure measurement from a component of the first modular filtration unit upstream from the pre-filter and a second pressure measurement from the pre-filter unit downstream from the pre-filter.

11. The HEPA filtration system of claim 10, where the first pressure drop exceeding a first threshold indicates that the pre-filter is clogged and needs to be replaced.

12. The HEPA filtration system of claim 10, wherein the second pressure drop indicator is configured to obtain a second pressure measurement from a component of the first modular filtration unit upstream from the HEPA filter and downstream from the pre-filter and a second pressure measurement from the HEPA filter unit downstream from the HEPA filter.

13. The HEPA filtration system of claim 12, where the second pressure drop exceeding a second threshold indicates that the HEPA filter is clogged and needs to be replaced.

14. The HEPA filtration system of claim 4, wherein the HEPA filter unit comprises:
a first adjustable slide plate; and
a second adjustable slide plate;
wherein the first adjustable slide plate and the second adjustable slide plate are configured to move laterally to apply pressure to an upstream side of the HEPA filter to cause a gasket of the HEPA filter to be compressed against a sealing face of the HEPA filter unit.

15. The HEPA filtration system of claim 14, wherein the first adjustable slide plate comprises a first adjustment bolt, a plurality of first low friction elements for converting torque applied to the first adjustment bolt into lateral movement of the first adjustable slide plate.

16. The HEPA filtration system of claim 15, wherein the first adjustable slide plate further comprises a first serrated locking washer disposed on the first adjustment bolt to prevent the first adjustment bolt from moving due to force applied to the first adjustable slide plate by the HEPA filter.

17. The HEPA filtration system of claim 15, wherein the second adjustable slide plate comprises a second adjustment bolt, a plurality of second low friction elements for converting torque applied to the second adjustment bolt into lateral movement of the second adjustable slide plate, and wherein the second adjustable slide plate further comprises a second serrated locking washer disposed on the second adjustment bolt to prevent the second adjustment bolt from moving due to force applied to the second adjustable slide plate by the HEPA filter.

18. The HEPA filtration system of claim 1, wherein the HEPA filtration system further comprises a set of skids on which the first modular filtration unit, the second modular filtration unit, and the blower unit are disposed.

19. The HEPA filtration system of claim 1, further comprising an ultraviolet (UV) disinfection component configured to sanitize an interior of the first modular filtration unit by exposing the interior of the first modular filtration unit to UV light for a predetermined period of time.

20. The HEPA filtration system of claim 1, further comprising a variable frequency drive and controller logic configured to:
monitor a pressure differential across a blower plenum of the blower unit;
calculate a current airflow rate based on the pressure differential; and
automatically adjust a blower speed to maintain a consistent air flow rate through the HEPA filtration system.
